(19) United States
(12) Patent Application Publication
(10) Pub. No.: US 2025/0219187 A1
(43) Pub. Date: Jul. 3, 2025

(54) VEHICLE CONTROL DEVICE AND METHOD THEREOF

(71) Applicants: HYUNDAI MOTOR COMPANY, SEOUL (KR); KIA CORPORATION, SEOUL (KR)

(72) Inventor: Myung Hwan KIM, Hwaseong-si (KR)

(21) Appl. No.: 18/770,640

(22) Filed: Jul. 11, 2024

(30) Foreign Application Priority Data
Jan. 2, 2024 (KR) 10-2024-0000341

(51) Int. Cl. H01M 10/633; H01M 10/613; H01M 10/615; H01M 10/625; H01M 10/6568

(52) U.S. Cl. CPC H01M 10/633; H01M 10/613; H01M 10/615; H01M 10/625; H01M 10/6568; H01M 2220/20

(57) ABSTRACT

A vehicle control device and a method thereof are provided. The vehicle control device includes a processor, a memory, a battery, a battery heater, and a battery chiller. The processor determines a mode associated with a coolant, using at least one of a target distance of a vehicle, a traveling start time, or an outside air temperature, or any combination thereof, before the vehicle travels. The processor identifies a first threshold temperature using a designated first dataset, heats a temperature of the coolant up to the first threshold temperature using the battery heater, and identifies a second threshold temperature using a designated second dataset, in response to determining the mode associated with the coolant is a cool storage mode, and cools the temperature of the coolant up to the second threshold temperature using the battery chiller, while the coolant flows through the coolant flow line.

### CROSS-REFERENCE TO RELATED APPLICATION

This application claims the benefit of priority to Korean Patent Application No. 10-2024-0000341, filed in the Korean Intellectual Property Office on Jan. 2, 2024, the entire contents of which are incorporated herein by reference.

### TECHNICAL FIELD

The present disclosure relates to a vehicle control device and a method thereof, and more particularly, relates to technologies for adjusting a temperature of a coolant.

### BACKGROUND

In general, an electric vehicle or a hybrid electric vehicle drives its motor using electrical energy output from its battery to secure the drivability of a certain vehicle speed or more. Such an electric vehicle or a hybrid electric vehicle may be composed of a battery for generating electrical energy and a motor driving system for supplying the electrical energy generated by the battery to a motor. The motor driving system of the electric vehicle or the hybrid electric vehicle may be composed of power conversion parts, such as an inverter, a motor control unit, and a motor. Such power conversion parts may be pieces of equipment for generating high-temperature heat, which may cause heat generation when the vehicle is traveling. Because such heat generation has a bad influence on the performance of the power conversion parts and a driving distance of the vehicle, the electric vehicle or the hybrid electric vehicle may include a cooling system to address the heat generation. However, to address the heat generation, electrical energy for adjusting the temperature of a coolant may be additionally consumed when the vehicle is traveling, the driving distance of the vehicle may be reduced.

### SUMMARY

The present disclosure solves the above-mentioned problems occurring in the prior art while advantages achieved by the prior art are maintained intact.

An aspect of the present disclosure provides a vehicle control device for adjusting a temperature of a coolant before a vehicle travels and a method thereof.

Another aspect of the present disclosure provides a vehicle control device for increasing a drivable distance of a vehicle by adjusting a temperature of a coolant before the vehicle travels and a method thereof.

Another aspect of the present disclosure provides a vehicle control device for determining at least one of a heat storage mode or a cool storage mode depending on an outside air temperature and a method thereof.

Another aspect of the present disclosure provides a vehicle control device for identifying a target temperature of a coolant depending on an outside air temperature and a target distance and a method thereof.

Thus, the present disclosure provides a vehicle control device for adjusting a temperature of a coolant in advance in an electric vehicle or a hybrid electric vehicle to increase the entire driving distance of the vehicle through more efficient battery management.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control device may include a processor, a memory, a battery, a battery heater, and a battery chiller. The processor may be configured to determine a mode associated with a coolant for adjusting a temperature of the battery, using at least one of a target distance of a vehicle, a traveling start time, or an outside air temperature, or any combination thereof, before the vehicle travels, identify a first threshold temperature using a designated first dataset, in response to determining the mode associated with the coolant is a heat storage mode, and heat a temperature of the coolant up to the first threshold temperature using the battery heater, while the coolant flows through a coolant flow line connected with the battery, and identify a second threshold temperature using a designated second dataset, in response to determining the mode associated with the coolant is a cool storage mode, and cool the temperature of the coolant up to the second threshold temperature using the battery chiller, while the coolant flows through the coolant flow line.

In an embodiment, the processor may be configured to determine the mode associated with the coolant as the heat storage mode, if the outside air temperature is less than or equal to a first external temperature, and identify the first threshold temperature, using the designated first dataset indicating temperature values of the coolant, the temperature values being set according to a temperature being less than or equal to the first external temperature and the target distance.

In an embodiment, the processor may be configured to determine the mode associated with the coolant as the cool storage mode, if the outside air temperature is greater than or equal to a second external temperature, and identify the second threshold temperature, using the designated second dataset indicating temperature values of the coolant, the temperature values being set according to a temperature being greater than or equal to the second external temperature and the target distance.

In an embodiment, the processor may be configured to calculate a first spending time spent to heat the temperature of the coolant up to the first threshold temperature, using the outside air temperature and the first threshold temperature, if determining the mode associated with the coolant as the heat storage mode, and initiate to drive the battery heater for heating the temperature of the coolant before the first spending time from the traveling start time.

In an embodiment, the processor may be configured to calculate a second spending time spent to cool the temperature of the coolant up to the second threshold temperature, using the outside air temperature and the second threshold temperature, if determining the mode associated with the coolant as the cool storage mode, and initiate to drive the battery chiller for cooling the temperature of the coolant before the second spending time from the traveling start time.

In an embodiment, the processor may be configured to identify a first increase distance to increase by not heating the temperature of the coolant while the vehicle is traveling, based on the temperature of the coolant, the temperature being heated up to the first threshold temperature, if determining the mode associated with the coolant as the heat storage mode.

In an embodiment, the processor may be configured to identify a second increase distance to increase by not cooling the temperature of the coolant while the vehicle is traveling, based on the temperature of the coolant, the temperature being cooled up to the second threshold temperature, if determining the mode associated with the coolant as the cool storage mode.

The vehicle control device according to an embodiment of the present disclosure may further include a water pump that causes flow of the coolant. In an embodiment, the processor may be configured to change the temperature of the coolant, using at least one of the battery heater or the battery chiller, while the coolant flows through the coolant flow line using the water pump, based on determining the mode associated with the coolant.

In an embodiment, the processor may be configured to additionally adjust the first threshold temperature or the second threshold temperature based on a weight.

In an embodiment, the processor may be configured to determine the mode associated with the coolant, if a state of charge (SOC) of the battery is greater than or equal to a threshold charging capacity.

According to another aspect of the present disclosure, a vehicle control method may include determining a mode associated with a coolant for adjusting a temperature of the battery, using at least one of a target distance of a vehicle, a traveling start time, or an outside air temperature, or any combination thereof, before the vehicle travels, identifying a first threshold temperature using a designated first dataset, if determining the mode associated with the coolant as a heat storage mode, and heating a temperature of the coolant up to the first threshold temperature using a battery heater, while the coolant flows through a coolant flow line connected with the battery, and identifying a second threshold temperature using a designated second dataset, if determining the mode associated with the coolant as a cool storage mode, and cooling the temperature of the coolant up to the second threshold temperature using a battery chiller, while the coolant flows through the coolant flow line.

In an embodiment, the determining of the mode associated with the coolant may include determining the mode associated with the coolant as the heat storage mode, if the outside air temperature is less than or equal to a first external temperature, and identifying the first threshold temperature, using the designated first dataset indicating temperature values of the coolant, the temperature values being set according to a temperature being less than or equal to the first external temperature and the target distance.

In an embodiment, the determining of the mode associated with the coolant may include determining the mode associated with the coolant as the cool storage mode, if the outside air temperature is greater than or equal to a second external temperature, and identifying the second threshold temperature, using the designated second dataset indicating temperature values of the coolant, the temperature values being set according to a temperature being greater than or equal to the second external temperature and the target distance.

In an embodiment, the identifying of the first threshold temperature may include calculating a first spending time spent to heat the temperature of the coolant up to the first threshold temperature, using the outside air temperature and the first threshold temperature, if determining the mode associated with the coolant as the heat storage mode, and initiating to drive the battery heater for heating the temperature of the coolant before the first spending time from the traveling start time.

In an embodiment, the identifying of the second threshold temperature may include calculating a second spending time spent to cool the temperature of the coolant up to the second threshold temperature, using the outside air temperature and the second threshold temperature, if determining the mode associated with the coolant as the cool storage mode, and initiating to drive the battery chiller for cooling the temperature of the coolant before the second spending time from the traveling start time.

In an embodiment, the heating of the temperature of the coolant up to the first threshold temperature may include identifying a first increase distance to increase by not heating the temperature of the coolant while the vehicle is traveling, based on the temperature of the coolant, the temperature being heated up to the first threshold temperature, if determining the mode associated with the coolant as the heat storage mode.

In an embodiment, the cooling of the temperature of the coolant up to the second threshold temperature may include identifying a second increase distance to increase by not cooling the temperature of the coolant while the vehicle is traveling, based on the temperature of the coolant, the temperature being cooled up to the second threshold temperature, if determining the mode associated with the coolant as the cool storage mode.

In an embodiment, the determining of the mode associated with the coolant may include changing the temperature of the coolant, using at least one of the battery heater or the battery chiller, while the coolant flows through the coolant flow line using a water pump, based on determining the mode associated with the coolant.

In an embodiment, the vehicle control method may further include additionally adjusting the first threshold temperature or the second threshold temperature based on a weight.

In an embodiment, the determining of the mode associated with the coolant may include determining the mode associated with the coolant, if a state of charge (SOC) of the battery is greater than or equal to a threshold charging capacity.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example of a block diagram associated with a vehicle control device according to an embodiment of the present disclosure;

FIG. 2 illustrates an example of a thermal management circuit associated with a vehicle including a vehicle control device according to an embodiment of the present disclosure;

FIG. 3 illustrates an example of a battery thermal management circuit included in a vehicle control device according to an embodiment of the present disclosure;

FIG. 4 illustrates an example of a flowchart illustrating an operation for identifying a mode associated with a coolant in a vehicle control device according to an embodiment;

FIG. 5 illustrates an example of a flowchart illustrating an operation of adjusting a temperature of a coolant based on a heat storage mode in a vehicle control device according to an embodiment;

FIG. 6 illustrates an example of a flowchart illustrating an operation of adjusting a temperature of a coolant based on a cold storage mode in a vehicle control device according to an embodiment;

FIG. 7 illustrates an example of a flowchart for describing a vehicle control method according to an embodiment of the present disclosure; and

FIG. 8 illustrates a computing system associated with a vehicle control apparatus or a vehicle control method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The term “module” used in various embodiments of the present disclosure may include a unit implemented with hardware, software, or firmware, and may be interchangeably used with terms, for example, “logic,” “logic block,” “part,” or “circuitry”. A module may be an integral part, or a minimum unit or portion thereof, adapted to perform one or more functions. In an embodiment, the module may be implemented in the form of an application-specific integrated circuit (ASIC). According to various embodiments, operations performed by the module, the program, or another component may be carried out sequentially, in parallel, or repeatedly, or one or more of the operations may be executed in a different order or omitted, or one or more other operations may be added.

Various embodiments of the present disclosure may be implemented as software (e.g., a program) including one or more instructions stored in a storage medium (e.g., an internal memory or an external memory) readable by a machine (e.g., a vehicle control device 100). For example, a processor (e.g., a processor 110) of the device (e.g., the vehicle control device 100) may invoke at least one of the stored one or more instructions from the storage medium and may execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not differentiate between where data is semipermanently stored in the storage medium and where data is temporarily stored in the storage medium.

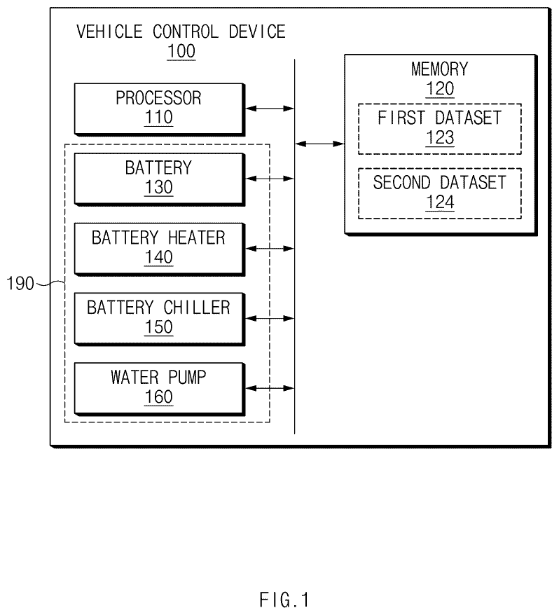

Hereinafter, embodiments of the present disclosure will be described in detail with reference to FIGS. 1 to 8.

FIG. 1 illustrates an example of a block diagram associated with a vehicle control device according to an embodiment of the present disclosure.

Referring to FIG. 1, a vehicle control device 100 according to an embodiment of the present disclosure may be implemented inside or outside a vehicle, and some of the components included in the vehicle control device 100 may be implemented inside or outside the vehicle. In this case, the vehicle control device 100 may be integrally configured with control units in the vehicle or may be implemented as a separate device to be connected with the control units of the vehicle by a separate connection means. For example, the vehicle control device 100 may further include components which are not shown in FIG. 1. The vehicle may include an electric vehicle capable of traveling by driving a motor based on electrical energy output from the battery 130 and/or a hybrid electric vehicle.

According to an embodiment, the vehicle control device 100 may include at least one of a processor 110, a memory 120, a battery 130, a battery heater 140, a battery chiller 150, or a water pump 160. The processor 110, the memory 120, the battery 130, the battery heater 140, the battery chiller 150, and the water pump 160 may be electronically or operably coupled with each other by an electronical component including a communication bus. Hereinafter, that pieces of hardware are operably coupled with each other may mean that a direct connection or an indirect connection between the pieces of hardware is established in a wired or wireless manner, such that second hardware is controlled by first hardware among the pieces of hardware. They are illustrated based on the different blocks, but an embodiment is not limited thereto. Some (e.g., at least some of the processor 110, the memory 120, and a communication circuit (not shown)) of the pieces of hardware of FIG. 1 may be included in a single integrated circuit such as a system on a chip (SoC).

The processor 110 of the vehicle control device 100 according to an embodiment may include hardware for processing data based on one or more instructions. The hardware for processing the data may include, for example, an arithmetic and logic unit (ALU), a floating point unit (FPU), a field programmable gate array (FPGA), a central processing unit (CPU), a micro controller unit (MCU), and/or an application processor (AP). The number of the processors 110 may be one or more in number. For example, the processor 110 may have a structure of a multi-core processor such as a dual core, a quad core, or a hexa core. Operations below may be performed by the processor 110.

According to an embodiment, the memory 120 of the vehicle control device 100 may include a hardware component for storing data and/or an instruction input and/or output from the processor 110. The memory 120 may include, for example, a volatile memory, such as a random-access memory (RAM), and/or a non-volatile memory, such as a read-only memory (ROM). The volatile memory may include at least one of, for example, a dynamic RAM (DRAM), a static RAM (SRAM), a cache RAM, or a pseudo SRAM (PSRAM). The non-volatile memory may include at least one of, for example, a programmable ROM (PROM), an erasable PROM (EPROM), an electrically erasable PROM (EEPROM), a flash memory, a hard disk, a compact disc, a solid state drive (SSD), or an embedded multi-media card (eMMC).

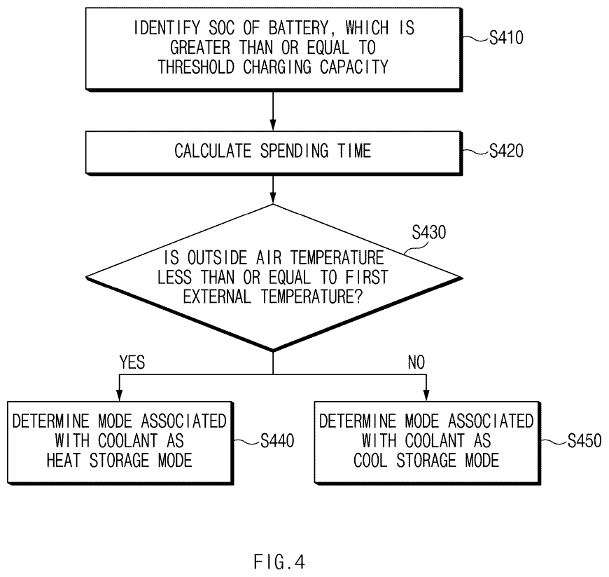

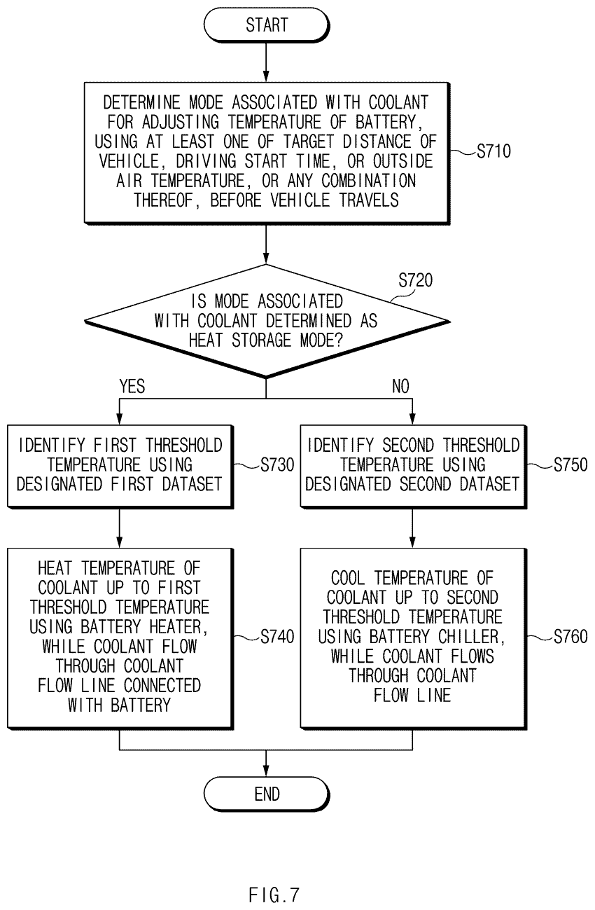

One or more instructions indicating calculation and/or an operation to be performed for data by the processor 110 may be stored in the memory 120 of the vehicle control device 100 according to an embodiment. A set of the one or more instructions may be referred to as firmware, an operating system, a process, a routine, a sub-routine, and/or an application. For example, when a set of a plurality of instructions distributed in the form of an operating system, firmware, a driver, and/or an application is executed, the vehicle control device 100 and/or the processor 110 may perform at least one of the operations of FIGS. 4 and 7. Hereinafter, that software in the form of an operating system, firmware, a driver, and/or an application is installed in the vehicle control device 100 may mean that one or more instructions provided in the form of software are stored in the memory 120 of the vehicle control device 100, which may mean that one or more applications are stored in a format executable by the processor 110 of the vehicle control device 100 (e.g., as a file with an extension specified by an operating system of the vehicle control device 100).

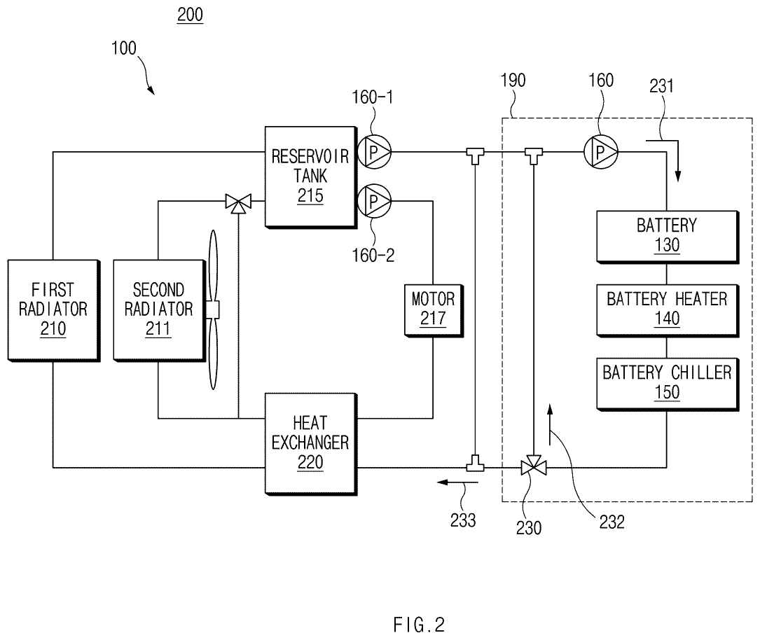

The battery 130 of the vehicle control device 100 according to an embodiment may output electrical energy (or power) to be consumed by another circuit and/or hardware components in the vehicle including the vehicle control device 100 from chemical energy. For example, a motor (e.g., a motor 217 of FIG. 2) may be driven using the electrical energy output from the battery 130.

For example, the battery 130 may include a battery cell, a battery module, or a battery pack. The battery 130 may include a capacitor or a secondary battery, which stores power depending on charging. For example, the battery 130 may be any one of a lithium (Li)-ion battery, a Li-ion polymer battery, a lead-acid battery, a nickel-cadmium (NiCd) battery, or a nickel-metal hydride (NiMH) battery. For example, the battery 130 may be charged by a power signal received from the outside.

For example, the vehicle control device 100 may adjust a temperature of the battery 130, using the battery heater 140 or a battery chiller 150 connected through a coolant flow line. The vehicle control device 100 may adjust a temperature of a coolant which flows (or circulates) through the coolant flow line connected with at least a part of the battery 130 using the battery heater 140 or the battery chiller 150, thus adjusting the temperature of the battery 130. The coolant flow line may penetrate at least a part of the battery 130. However, it is not limited thereto.

In an embodiment, the battery heater 140 of the vehicle control device 100 may increase the temperature of the battery 130. For example, the battery heater 140 may heat the coolant flowing through the coolant flow line to increase a temperature around the battery 130. The battery heater 140 may include a positive temperature coefficient (PTC) heater. The battery heater 140 may include a water-heated coolant heater.

In an embodiment, the battery chiller 150 of the vehicle control device 100 may decrease the temperature of the battery 130. For example, the battery chiller 150 may cool the coolant flowing through the coolant flow line to decrease a temperature around the battery 130. The battery chiller 150 may include an air-cooled battery chiller, a liquid-cooled battery chiller, an engine-linked battery chiller, a heat pump type battery chiller, and/or a dedicated battery chiller. The battery chiller 150 may include an expansion valve (EXV) to control flow of the coolant (or a cooling fluid).

For example, the battery chiller 150 may decrease the temperature of the coolant, using a heat exchanger (e.g., a water-cooled heat exchanger). The coolant flowing through the coolant flow line may absorb heat from the battery 130. The battery chiller 150 may exchange heat between the coolant and a refrigerant associated with an air conditioner system, using the heat exchanger, to decrease the temperature of the coolant. The vehicle control device 100 may decrease a temperature of the battery 130, using the coolant, the temperature of which decreases by means of the battery chiller 150. However, it is not limited thereto.

In an embodiment, the vehicle control device 100 may cause the flow of the coolant through the coolant flow line, using the water pump 160. The water pump 160 may include an electric water pump (EWP). The vehicle control device 100 may adjust the temperature of the battery 130 by means of the coolant flowing based on the water pump 160.

The vehicle control device 100 according to an embodiment may include a battery thermal management circuit 190 for thermal management of the battery 130. The battery thermal management circuit 190 may include the battery 130, the battery heater 140, the battery chiller 150, and/or the water pump 160. The battery 130, the battery heater 140, the battery chiller 150, and the water pump 160 may be electronically and/or operably coupled with each other through the coolant flow line. The vehicle control device 100 may adjust the temperature of the coolant flowing through the coolant flow line, using the battery thermal management circuit 190.

The vehicle control device 100 according to an embodiment may identify a state of charge (SOC) of the battery 130. If the SOC of the battery 130 is greater than or equal to a threshold charging capacity, the vehicle control device 100 may determine a mode associated with the coolant. The mode associated with the coolant may include a mode for adjusting the temperature of the coolant before the vehicle travels. For example, the vehicle control device 100 may determine a mode for adjusting the temperature of the coolant, based on a user input indicating whether to adjust the temperature of the coolant, based on identifying the SOC which is greater than or equal to the threshold charging capacity.

For example, the vehicle control device 100 may determine the mode associated with the coolant for adjusting the temperature of the battery 130, using at least one of a target distance of the vehicle, a traveling start time (or driving start time), or an outside air temperature, or any combination thereof, before the vehicle travels. The vehicle control device 100 may obtain an input indicating the target distance of the vehicle or the traveling start time, before the vehicle travels. The target distance of the vehicle may include a distance from a current location of the vehicle to a destination. The vehicle control device 100 may identify the target distance of the vehicle, using a mapping table for identifying the target distance. The mapping table may indicate a relationship between the traveling start time and the target distance. The vehicle control device 100 may change the mapping table depending on a user. The vehicle control device 100 may identify a movement distance of the vehicle over time. The vehicle control device 100 may obtain the mapping table using the identified movement distance of the vehicle and a time corresponding to the movement distance. However, it is not limited thereto.

The vehicle control device 100 according to an embodiment may identify an outside air temperature. The vehicle control device 100 may determine the mode associated with the coolant as at least one of a heat storage mode or a cold storage mode, depending on the outside air temperature.

The vehicle control device 100 according to an embodiment may cause the flow of the coolant through the coolant flow line, using the water pump 160, based on determining the mode associated with the coolant. While the coolant flows through the coolant flow line, the vehicle control device 100 may change the temperature of the coolant, using at least one of the battery heater 140 or the battery chiller 150.

In an embodiment, if the outside air temperature is less than or equal to a first external temperature (e.g., about 0 degrees Celsius (° C.)), the vehicle control device 100 may determine the mode associated with the coolant as the heat storage mode. For example, if determining the mode associated with the coolant as the heat storage mode, the vehicle control device 100 may identify a threshold temperature using a first dataset 123. The threshold temperature may indicate a heating value according to the target distance for each outside air temperature.

For example, the first dataset 123 may indicate temperature values of the coolant, which are set according to a temperature, which is less than or equal to the first external temperature, and the target distance. The first dataset 123 may be represented as Table 1 below.

TABLE 1

| | Target distance | | | |
|---|---|---|---|---|
| Outside air | | | | 300 km |
| temperature | 50 km | 100 km | 200 km | or more |
| T < −25 | 50 | 65 | 75 | 80 |
| degrees | degrees | degrees | degrees | degrees |
| −25 degrees < T < −10 | 50 | 60 | 70 | 80 |
| degrees | degrees | degrees | degrees | degrees |
| −10 degrees < T | 50 | 55 | 60 | 65 |
| | degrees | degrees | degrees | degrees |

Referring to Table 1 above, if identifying a temperature at which the outside air temperature is less than or equal to the first external temperature (e.g., about 25 degrees), the vehicle control device 100 may determine the mode associated with the coolant as the heat storage mode. The heat storage mode may include a mode for increasing the temperature of the coolant. The vehicle control device 100 may identify a first target distance (e.g., about 50 km). The vehicle control device 100 may identify a first threshold temperature (e.g., about 50 degrees), based on identifying the first external temperature and the first target distance. While the coolant flows through the coolant flow line connected with the battery 130, the vehicle control device 100 may heat the temperature of the coolant up to the first threshold temperature using the battery heater 140. For example, if determining the mode associated with the coolant as the heat storage mode, the vehicle control device 100 may calculate (or identify) a first spending time spent to heat the temperature of the coolant up to the first threshold temperature, using the outside air temperature (e.g., about −25 degrees or less) and the first threshold temperature (e.g., about 50 degrees). The vehicle control device 100 may initiate to drive the battery heater 140 for heating the temperature of the coolant before the first spending time from the traveling start time. For example, the first spending time may be identified based on the outside air temperature, the first threshold temperature, and/or performance of the heat storage mode (or a heat storage system).

If determining the mode associated with the coolant as the heat storage mode, the vehicle control device 100 according to an embodiment may identify a first increase distance to increase by not heating the temperature of the coolant while the vehicle is traveling, based on the temperature of the coolant, which is heated up to the first threshold temperature.

For example, after identifying the temperature of the coolant corresponding to the first threshold temperature, the vehicle control device 100 may notify the user of the first increase distance. After the vehicle ignition is on, the vehicle control device 100 may notify the user of the first increase distance. As an example, the vehicle control device 100 may transmit the first increase distance to a user terminal. The user terminal may include, for example, a smartphone, a smartpad, and/or a tablet PC. The user terminal may include a smart accessory such as a smartwatch and/or a head-mounted device (HMD).

In an embodiment, if the outside air temperature is greater than or equal to a second external temperature (e.g., 30 degrees), the vehicle control device 100 may determine the mode associated with the coolant as the cool storage mode. The vehicle control device 100 may identify a second threshold temperature, using a second dataset 124 indicating temperature values of the coolant, which are set according to a temperature, which is greater than or equal to the second external temperature, and the target distance. The second dataset 124 may be represented as Table 2 below.

TABLE 2

Target distance

| Outside air | | | | 300 km |
|---|---|---|---|---|
| temperature | 50 km | 100 km | 200 km | or more |
| 36 degrees < T | 15 | 10 | 10 | 5 |
| | degrees | degrees | degrees | degrees |
| 30 degrees < T < 36 | 20 | 15 | 15 | 15 |
| degrees | degrees | degrees | degrees | degrees |
| 25 degrees < T < 30 | 20 | 20 | 15 | 15 |
| degrees | degrees | degrees | degrees | degrees |

Referring to Table 2 above, if the outside air temperature is greater than or equal to the second external temperature (e.g., about 36 degrees), the vehicle control device 100 according to an embodiment may determine the mode associated with the coolant as the cool storage mode. The vehicle control device 100 may identify a second target distance (e.g., about 50 km). The vehicle control device 100 may identify the second threshold temperature (e.g., about 15 degrees), based on identifying the outside air temperature and the second target distance. The vehicle control device 100 may cause the flow of the coolant through the water pump 160. While the coolant flows through the coolant flow line, the vehicle control device 100 may cool the temperature of the coolant up to the second threshold temperature using the battery chiller 150.

For example, when determining the mode associated with the coolant as the cool storage mode, the vehicle control device 100 may calculate a second spending time spent to cool the temperature of the coolant up to the second threshold temperature, using the outside air temperature (e.g., about 35 degrees or more) and the second threshold temperature (e.g., about 15 degrees). The vehicle control device 100 may initiate to drive the battery chiller 150 for cooling the temperature of the coolant before the second spending time from the traveling start time. For example, the second spending time may be identified based on the outside air temperature, the second threshold temperature, and/or performance of the cool storage mode (or a cool storage system).

When determining the mode associated with the coolant as the cool storage mode, the vehicle control device 100 according to an embodiment may identify a second increase distance to increase by not cooling the temperature of the coolant while the vehicle is traveling, based on the temperature of the coolant, which is cooled up to the second threshold temperature. After identifying the temperature of the coolant corresponding to the second threshold temperature, the vehicle control device 100 may notify the user of the second increase distance.

The vehicle control device 100 according to an embodiment may set a weight for reducing an error between the temperature of the coolant and the increase distance to change according to the temperature of the coolant. For example, the vehicle control apparatus 100 may divide a weight based on a stage. The weight may be mapped to a predetermined value in stages.

The vehicle control device 100 according to an embodiment may additionally adjust (or change) the target temperature (e.g., the first threshold temperature and the second threshold temperature) of the coolant based on the weight. The weight may indicate severity to give an extra margin to the temperature of the coolant. The severity may indicate whether the user will actively use the operation of adjusting the temperature of the coolant. However, it is not limited thereto.

For example, referring to Table 1 above, if identifying the first threshold temperature (e.g., about 50 degrees), the vehicle control device 100 may additionally add the weight (e.g., about 5 degrees) to the first threshold temperature to change the first threshold temperature. The vehicle control device 100 may heat the temperature of the coolant up to the changed first threshold temperature. However, it is not limited thereto. The vehicle control device 100 may set the weight, based on an input for changing the weight.

The vehicle control device 100 according to an embodiment of the present disclosure, which is described above, may adjust the temperature of the coolant, before the vehicle travels. The vehicle control device 100 may adjust the temperature of the coolant before the vehicle travels, thus reducing additional power consumption to adjust the temperature of the coolant while the vehicle is traveling. The vehicle control device 100 may reduce power consumption for adjusting the temperature of the coolant while the vehicle is traveling, thus increasing a movable driving distance of the vehicle.

FIG. 2 illustrates an example of a thermal management circuit 200 associated with a vehicle including a vehicle control device according to an embodiment of the present disclosure. A vehicle control device 100 according to an embodiment may be referred to a vehicle control device 100 of FIG. 1.

A vehicle associated with the vehicle control device 100 according to an embodiment may include the thermal management circuit 200 for managing a temperature of a motor 217 for moving the vehicle and/or a temperature of a battery 130 for transmitting electrical energy to the motor 217. In an example, the thermal management circuit 200 may include one or more radiators 210 and 211, a reservoir tank 215, a heat exchanger 220, the motor 217, and/or a battery thermal management circuit 190 of FIG. 1. In an example, at least some of hardware components included in the thermal management circuit 200 may be connected with each other along a coolant flow line. At least a part of the coolant flow line may form a closed circuit.

In an embodiment, the thermal management circuit 200 may include the first radiator 210 and the second radiator 211. The first radiator 210 and the second radiator 211 may be arranged on the front of the vehicle and may include a cooling pan.

In an embodiment, the first radiator 210 may be associated with a cooling system of the vehicle. The first radiator 210 may reduce a temperature of a coolant flowing along the coolant flow line, through heat exchange with air outside the vehicle, to manage a temperature of the battery 130. The first radiator 210 may be referred to as a low temperature radiator (LTR).

In an embodiment, the second radiator 211 may be used to manage a temperature of the motor 217 for driving the vehicle. The second radiator 211 may be used to manage the temperature of the motor 217 which generates a relatively high temperature among the components in the vehicle. The second radiator 211 may be referred to as a high temperature radiator (HTR).

In an embodiment, the thermal management circuit 200 may include the reservoir tank 215. The reservoir tank 215 may be used to adjust pressure of the coolant flowing along the coolant flow line. The pressure of the coolant flowing along the coolant flow line may be changed by heat generated by the battery 130 or the motor 217. The reservoir tank 215 may adjust the changed pressure of the coolant within a stable range. The reservoir tank 215 may be used to maintain a level (or an amount) of the coolant. The reservoir tank 215 may include one or more water pumps 160-1 and 160-2.

In an embodiment, the water pump 160-1 may cause flow of the coolant along the coolant flow line for managing the temperature of the motor 217. The coolant may bypass the motor 217, the heat exchanger 220, and/or the second radiator 211 from the water pump 160-1 and may circulate along the coolant flow line for managing the temperature of the motor 217. In an embodiment, the water pump 160-2 may cause flow of the coolant along the coolant flow line for managing the temperature of the battery 130. However, it is not limited thereto.

In an embodiment, the motor 217 may include a processor (e.g., an intelligent cruise control unit (ICCU)) for managing an intelligent cruise control system of the vehicle, an inverter, and a motor oil cooler. The intelligent cruise control system may include a system for managing a distance from another vehicle and a movement speed of the other vehicle while the vehicle is traveling. For example, the inverter may be used to convert DC power output from the battery 130 into AC power. The motor oil cooler may be used to manage a temperature of a motor oil for reducing a friction between the components in the motor 217.

In an embodiment, the thermal management circuit 200 may include the heat exchanger 220. The heat exchanger 220 may be used for heat exchange between the coolant flowing along the coolant flow line for managing the temperature of the motor 217 and another coolant flowing along the coolant flow line for managing the temperature of the battery 130. The heat exchanger 220 may be used for heat exchange between a refrigerant associated with the air conditioner cooling system and the coolant associated with the temperature of the motor 217 or the temperature of the battery 130. However, it is not limited thereto.

The battery thermal management circuit 190 of the vehicle control device 100 according to an embodiment may include a water pump 160, the battery 130, a battery heater 140, a battery chiller 150, and/or a valve 230. The valve may include a 3-way valve. For example, before the vehicle travels, the vehicle control device 100 may determine a mode associated with the coolant. If determining the mode associated with the coolant as a cool storage mode or a heat storage mode, the vehicle control device 100 may initiate to drive the water pump 160 to cause flow of the coolant along the coolant flow line in the battery thermal management circuit 190. The vehicle control device 100 may cause flow of the coolant to flow along a direction 231, based on the driving of the water pump 160. The vehicle control device 100 may adjust the temperature of the coolant bypassing the battery 130 to flow, using the battery heater 140 or the battery chiller 150, based on the driving of the water pump 160. The vehicle control device 100 may cause the coolant, the temperature of which is adjusted by bypassing the battery heater 140 or the battery chiller 150, to flow along a direction 232 between the direction 232 or a direction 233, using the valve 230. The vehicle control device 100 may block a hall corresponding to the direction 233, based on determining the mode associated with the coolant, before the vehicle travels, thus controlling the flow of the coolant to flow along the direction 232. However, it is not limited thereto.

If the vehicle control device 100 according to an embodiment, which is described above, drives the motor 217, using electrical energy output from the battery 130, and executes the mode associated with the coolant, while the vehicle is traveling, a drivable distance of the vehicle may be reduced. The vehicle control device 100 may execute the mode associated with the coolant, before the vehicle travels, and may use all of electrical energy output from the battery 130 to drive the motor 217, after the vehicle travels, thus increasing the drivable distance of the vehicle.

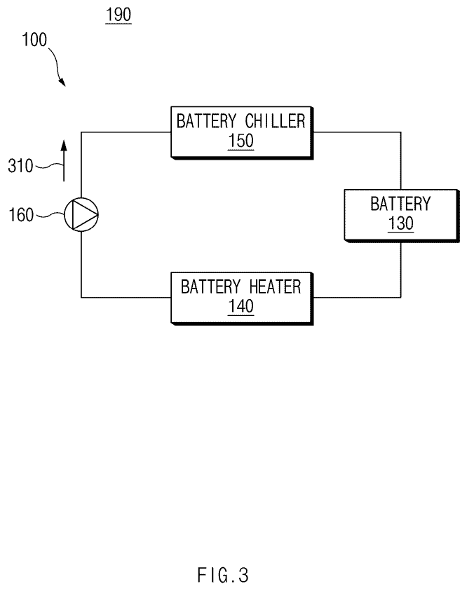

Hereinafter, a description of the battery thermal management circuit 190 will be described in detail with reference to FIG. 3.

FIG. 3 illustrates an example of a battery thermal management circuit 190 included in a vehicle control device according to an embodiment of the present disclosure. Referring to FIG. 3, a simplified block diagram of the battery thermal management circuit 190 used for a vehicle control device 100 according to an embodiment to execute a mode associated with a coolant is illustrated.

Before a vehicle travels, the vehicle control apparatus 100 according to an embodiment may determine whether to adjust a temperature of a coolant. The vehicle control device 100 may identify whether to adjust the temperature of the coolant, based on a user input. As an example, the capacity of the coolant may be 8 liter (L).

For example, the vehicle control device 100 may identify whether to adjust the temperature of the coolant, based on a designated reservation time. The designated reservation time may be before a spending time from a traveling start time of the vehicle. However, it is not limited thereto.

The vehicle control device 100 according to an embodiment may identify an SOC of a battery 130, based on determination indicating adjusting the temperature of the coolant. For example, if identifying the SOC of the battery 130, which is less than a threshold charging capacity, the vehicle control device 100 may temporarily refrain from the execution of the mode associated with the coolant.

For example, if identifying the SOC of the battery 130, which is greater than or equal to the threshold charging capacity, the vehicle control device 100 may initiate to execute the mode associated with the coolant. For example, before the vehicle travels, the vehicle control device 100 may determine the mode associated with the coolant for adjusting the temperature of the coolant, using at least one of a target distance of the vehicle, a traveling start time, or an outside air temperature, or any combination thereof.

The vehicle control device 100 according to an embodiment may determine the mode associated with the coolant as a cool storage mode or a heat storage mode, based on the outside air temperature. For example, if determining the mode associated with the coolant as the heat storage mode, the vehicle control device 100 may set a target temperature (e.g., a first threshold temperature of FIG. 1) of the coolant, using a first dataset (e.g., a first dataset 123 of FIG. 1). If determining the mode associated with the coolant as the heat storage mode, the vehicle control device 100 may initiate to drive a water pump 160 and a battery heater 140. The vehicle control device 100 may circulate the coolant, based on a direction 310 along a coolant flow line using the water pump 160. The vehicle control device 100 may heat the temperature of the coolant flowing along the coolant flow line, using the battery heater 140. The vehicle control device 100 may heat the temperature of the coolant up to the target temperature of the coolant, which is set using the first dataset. The vehicle control device 100 may circulate the coolant using the water pump 160 to heat the temperature of the coolant up to the target temperature of the coolant. However, it is not limited thereto.

For example, if determining the mode associated with the coolant as the cool storage mode, the vehicle control device 100 may set a target temperature (e.g., a second threshold temperature of FIG. 2) of the coolant, using a second dataset (e.g., a second dataset 124 of FIG. 1). If determining the mode associated with the coolant as the cool storage mode, the vehicle control device 100 may initiate to drive the water pump 160 and a battery chiller 150. The vehicle control device 100 may move the coolant, based on the direction 310 along the coolant flow line using the water pump 160. The vehicle control device 100 may cool the temperature of the coolant flowing along the coolant flow line, using the battery chiller 150. The vehicle control device 100 may cool the temperature of the coolant up to the target temperature of the coolant, which is set using the second dataset. The vehicle control device 100 may circulate the coolant using the water pump 160 to cool the temperature of the coolant up to the target temperature of the coolant. However, it is not limited thereto.

If the temperature of the coolant changes to the target temperature of the coolant based on the execution of the mode associated with the coolant, the vehicle control device 100 according to an embodiment may stop executing the mode associated with the coolant. The vehicle control device 100 may temporarily stop driving the water pump 160, the battery chiller 150, and/or the battery heater 140, before the vehicle travels (or before the vehicle is ignition on), based on stopping executing the mode associated with the coolant. However, it is not limited thereto.

The vehicle control device 100 according to an embodiment may notify a user of an increase distance according to the changed temperature of the coolant, based on identifying ignition on. The vehicle control device 100 may more increase a movement distance of the vehicle, compared to the same SOC of the battery, if executing the mode associated with the coolant before the vehicle travels, than if not executing the mode associated with the coolant.

FIG. 4 illustrates an example of a flowchart illustrating an operation for identifying a mode associated with a coolant in a vehicle control device according to an embodiment. Hereinafter, it is assumed that a vehicle control device 100 of FIG. 1 performs a process of FIG. 4. Furthermore, in a description of FIG. 4, an operation described as being performed by a vehicle control device may be understood as being controlled by a processor 110 of the vehicle control device 100. The respective operations of FIG. 4 may be sequentially performed, but are not necessarily sequentially performed. For example, an order of the respective operations may be changed, and at least two operations may be performed in parallel.

Referring to FIG. 4, in S410, the vehicle control device according to an embodiment may identify an SOC of a battery, which is greater than or equal to a threshold charging capacity. The vehicle control device may identify the SOC of the battery in a designated reservation time before a vehicle travels (e.g., before a spending time from a traveling start time). The vehicle control device may identify the SOC of the battery, which is greater than or equal to the threshold charging capacity, in the designated reservation time before the vehicle travels (e.g., before the spending time from a traveling start time), while the battery is being charged. The vehicle control device may set a mode for adjusting a temperature of a coolant, based on identifying the SOC of the battery, which is greater than or equal to the threshold charging capacity.

Referring to FIG. 4, in S420, the vehicle control device according to an embodiment may calculate a spending time. For example, the spending time may indicate a time taken to change the temperature of the coolant to a target temperature (e.g., a first threshold temperature or a second threshold temperature of FIG. 1). The spending time may be identified according to a target temperature of the coolant, a current temperature of the coolant, and performance of a battery heater (or a battery chiller). The performance of the battery heater (or the battery chiller) may be identified, based on a heating rate (or a cooling rate) and/or efficiency.

Referring to FIG. 4, in S430, the vehicle control device according to an embodiment may identify an outside air temperature is less than or equal to a first external temperature. The vehicle control device may identify the outside air temperature to set a mode associated with the coolant to at least one of a cool storage mode or a heat storage mode. However, it is not limited thereto. For example, the vehicle control device may perform S430 to set the mode associated with the coolant and may then perform S420.

Referring to FIG. 4, if the outside air temperature is less than or equal to the first external temperature (S430—YES), in S440, the vehicle control device according to an embodiment may determine the mode associated with the coolant as the cool storage mode. The vehicle control device may initiate to drive a battery thermal management circuit (e.g., a battery thermal management circuit 190 of FIG. 1), based on determining the mode associated with the coolant as the cool storage mode. The vehicle control device may initiate to drive the battery heater between the battery chiller and the battery heater, based on determining the mode associated with the coolant as the heat storage mode.

For example, if the outside air temperature is greater than the first external temperature (S430—NO), in S450, the vehicle control device according to an embodiment may determine the mode associated with the coolant as the cool storage mode. The vehicle control device may initiate to drive the battery chiller between the battery chiller and the battery heater, based on determining the mode associated with the coolant as the cool storage mode.

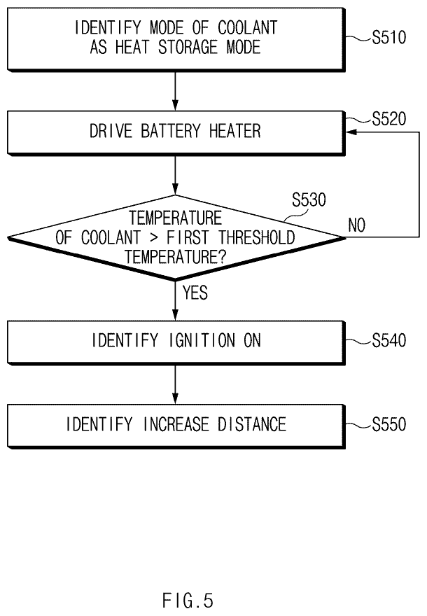

Hereinafter, a description will be given of an example of an operation of increasing the temperature of the coolant in the vehicle control device based on determining the mode associated with the coolant as the cool storage mode with reference to FIG. 5.

FIG. 5 illustrates an example of a flowchart illustrating an operation of adjusting a temperature of a coolant based on a heat storage mode in a vehicle control device according to an embodiment. Hereinafter, it is assumed that a vehicle control device 100 of FIG. 1 performs a process of FIG. 5. Furthermore, in a description of FIG. 5, an operation described as being performed by a vehicle control device may be understood as being controlled by a processor 110 of the vehicle control device 100. The respective operations of FIG. 5 may be sequentially performed, but are not necessarily sequentially performed. For example, an order of the respective operations may be changed, and at least two operations may be performed in parallel. At least one of the operations of FIG. 5 may be associated with at least one of operations of FIG. 4.

Referring to FIG. 5, in S510, the vehicle control device according to an embodiment may identify a mode of a coolant as a heat storage mode. S510 may be associated with S440 of FIG. 4.

In an embodiment, if an outside air temperature is less than or equal to a first external temperature (e.g., about 0 degrees), the vehicle control device may determine the mode associated with the coolant as the heat storage mode. For example, if determining the mode associated with the coolant as the heat storage mode, the vehicle control device may identify a threshold temperature using a first dataset (e.g., a first dataset 123 of FIG. 1). The threshold temperature may indicate a heating value according to a target distance according to the outside air temperature. For example, the first dataset may indicate temperature values of the coolant, which are set according to the external temperature and the target distance. For example, the vehicle control device may identify the target distance (e.g., about 50 km). The vehicle control device may identify a first threshold temperature (e.g., about 50 degrees), based on identifying the outside air temperature and the target distance.

Referring to FIG. 5, in S520, the vehicle control device according to an embodiment may drive a battery heater. While moving the coolant along a coolant flow line using a water pump, the vehicle control device may increase the temperature of the coolant up to the first threshold temperature using the battery heater. The vehicle control device may initiate to drive the battery heater for increasing the temperature of the coolant, before a spending time calculated in S420 of FIG. 4 from a traveling start time.

Referring to FIG. 5, in S530, the vehicle control device according to an embodiment may identify whether the temperature of the coolant is greater than the first temperature. If the temperature of the coolant is less than or equal to the first threshold temperature (S530—NO), the vehicle control device may perform S520. The vehicle control device may circulate the coolant along the coolant flow line using the water pump, until identifying the temperature of the coolant, which corresponds to the first threshold temperature, the vehicle control device may repeatedly perform S520 to heat the temperature of the coolant.

If the temperature of the coolant is greater than the first threshold temperature (S530—YES), in S540, the vehicle control device according to an embodiment may identify ignition on. The ignition on may include key on, an electric vehicle (EV) ready signal, and/or a start signal.

Referring to FIG. 5, in S550, the vehicle control device according to an embodiment may identify an increase distance. If determining the mode associated with the coolant as the heat storage mode, the vehicle control screen according to an embodiment may identify an increase distance to increase by not heating the temperature of the coolant while the vehicle is traveling, based on the temperature of the coolant, which is heated up to threshold temperature. For example, after identifying the temperature of the coolant, which corresponds to the first threshold temperature, the vehicle control device may notify a user of the increase distance. After the ignition on, the vehicle control device may notify the user of the increase distance. The increase distance may be obtained by using electrical energy to be consumed in a battery to adjust the temperature of the coolant while the vehicle is traveling to drive a motor.

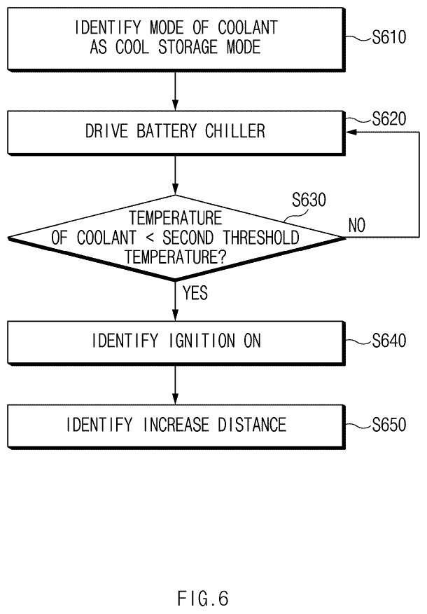

Hereinafter, a description will be given in detail of an example of an operation of cooling the coolant using a battery chiller, if the vehicle control device determines the mode of the coolant as a cool storage mode, with reference to FIG. 6,

FIG. 6 illustrates an example of a flowchart illustrating an operation of adjusting a temperature of a coolant based on a cold storage mode in a vehicle control device according to an embodiment. Hereinafter, it is assumed that a vehicle control device 100 of FIG. 1 performs a process of FIG. 6. Furthermore, in a description of FIG. 6, an operation described as being performed by a vehicle control device may be understood as being controlled by a processor 110 of the vehicle control device 100. The respective operations of FIG. 6 may be sequentially performed, but are not necessarily sequentially performed. For example, an order of the respective operations may be changed, and at least two operations may be performed in parallel. At least one of the operations of FIG. 6 may be associated with at least one of operations of FIG. 4.

Referring to FIG. 6, in S610, the vehicle control device according to an embodiment may identify a mode of a coolant as a cool storage mode. S610 may be associated with S450 of FIG. 4.

Referring to FIG. 6, in S620, the vehicle control device according to an embodiment may drive a battery chiller. While moving the coolant along a coolant flow line using a water pump, the vehicle control device may cool the coolant using the battery chiller. The vehicle control device may initiate to drive the battery chiller for cooling the temperature of the coolant before a spending time from a traveling start time. For example, if determining the mode of the coolant as the cool storage mode, the vehicle control device may calculate a spending time spent to cool the temperature of the coolant up to a second threshold temperature (e.g., about 15 degrees), using an outside air temperature (e.g., about 35 degrees or more) and the second threshold temperature. For example, the vehicle control device may obtain the second threshold temperature using a second dataset (e.g., a second dataset 124 of FIG. 1).

Referring to FIG. 6, in S630, the vehicle control device according to an embodiment may check whether the temperature of the coolant is less than the second threshold temperature. If the temperature of the coolant is greater than or equal to the second threshold temperature (S630—NO), the vehicle control device may repeatedly perform S620. The vehicle control device may repeatedly S620 to decrease the temperature of the coolant up to the second threshold temperature using the battery chiller, while moving the coolant along the coolant flow line.

Referring to FIG. 6, if the temperature of the coolant is less than the second threshold temperature (S630—YES), in S640, the vehicle control device according to an embodiment may identify ignition on. A time when the ignition on is identified may be referred to a traveling start time.

Referring to FIG. 6, in S650, the vehicle control device according to an embodiment may identify an increase distance. For example, the vehicle control device may identify the increase distance to increase by not cooling the temperature of the coolant while the vehicle is traveling, based on the temperature of the coolant, which is cooled up to the second threshold temperature. After ending the execution of the mode of the coolant, the vehicle control device may notify a user of the increase distance.

Hereinafter, a description will be given in detail of a vehicle control method according to an embodiment of the with reference to FIG. 7.

FIG. 7 illustrates an example of a flowchart for describing a vehicle control method according to an embodiment of the present disclosure. Hereinafter, it is assumed that a vehicle control device 100 of FIG. 1 performs a process of FIG. 7. Furthermore, in a description of FIG. 7, an operation described as being performed by a device may be understood as being controlled by a processor 110 of the vehicle control device 100. The respective operations of FIG. 7 may be sequentially performed, but are not necessarily sequentially performed. For example, an order of the respective operations may be changed, and at least two operations may be performed in parallel.

Referring to FIG. 7, In S710, the vehicle control method according to an embodiment may include determining a mode associated with a coolant for adjusting a temperature of a battery, using at least one of a target distance of a vehicle, a traveling start time, or an outside air temperature, or any combination thereof, before the vehicle travels. The vehicle control method may include determining the mode associated with the coolant, while the vehicle is being charged (or the battery is being charged). The vehicle control device may include determining the mode associated with the coolant, based on identifying an SOC of the battery, which is greater than or equal to a threshold charging capacity. The vehicle control method may include identifying the target distance of the vehicle and/or the traveling start time, based on driving data accumulated while the vehicle is traveling.

Referring to FIG. 7, in S720, the vehicle control method according to an embodiment may include determining whether to determine the mode of the coolant as a heat storage mode. The vehicle control method may include identifying whether to determine the mode associated with the coolant as the heat storage mode depending on the outside air temperature. The vehicle control method may include determining the mode associated with the coolant as the heat storage mode, based on identifying the outside air temperature which is less than or equal to a first external temperature (e.g., about 0 degrees). For example, the vehicle control method may include determining the mode associated with the coolant as a cool storage mode, based on identifying the outside air temperature which is greater than or equal to a second external temperature (e.g., about 30 degrees). The vehicle control method may include temporarily refraining from execution of the mode associated with the coolant, based on identifying the outside air temperature which is greater than the first external temperature and is less than the second external temperature. However, it is not limited thereto.

Referring to FIG. 7, if determining the mode associated with the coolant as the heat storage mode (S720—YES), in S730, the vehicle control method according to an embodiment may include identifying a first threshold temperature using a designated first dataset. The first dataset may be referred to a first dataset 123 of FIG. 1. The vehicle control method may include identifying the first threshold temperature according to the outside air temperature and the target distance, using the first dataset. The first threshold temperature may indicate a target temperature of the coolant.

Referring to FIG. 7, in S740, the vehicle control method according to an embodiment may include heating the temperature of the coolant up to the first threshold temperature using a battery heater, while the coolant flows through a coolant flow line connected with the battery. The vehicle control method may include initiating to drive the battery heater while circulating the coolant along the coolant flow line connected with the battery using a water pump (e.g., a water pump 160 of FIG. 3). The vehicle control method may increase the temperature of the coolant up to the first threshold temperature, based on initiating to drive the battery heater. The vehicle control method may include delivering heat, generated from the battery heater, to the coolant to heat the coolant.

The vehicle control method according to an embodiment may include at least temporarily ending the heat storage mode, if the temperature of the coolant is heated up to the first threshold temperature. The vehicle control method may have the effect of reducing consumption of the SOC of the battery based on at least temporarily ending the heat storage mode. The vehicle control method may include notifying a user of a movement distance additionally movable according to the heated coolant temperature, if the temperature of the coolant is heated up to the first threshold temperature. However, it is not limited thereto.

Referring to FIG. 7, if determining the mode associated with the coolant as a cool storage mode (S720—NO), in S750, the vehicle control method according to an embodiment may include identifying a second threshold temperature using a designated second dataset. The designated second dataset may be referred to a second dataset 124 of FIG. 1.

Referring to FIG. 7, in S760, the vehicle control method according to an embodiment may include cooling the temperature of the coolant up to the second threshold temperature using a battery chiller, while the coolant flows through the coolant flow line. The vehicle control method may include initiating to drive the battery chiller while circulating the coolant along the coolant flow line connected with the battery using the water pump (e.g., the water pump 160 of FIG. 3). The vehicle control method may be to decrease the temperature of the coolant up to the second threshold temperature, based on initiating to drive the battery chiller. The vehicle control method may include delivering heat of the coolant to the outside through the heat exchanger to cool the coolant. However, it is not limited thereto.

The vehicle control method according to an embodiment may include at least temporarily ending the cool storage mode, if the temperature of the coolant is cooled up to the second threshold temperature. The vehicle control method may include notifying the user of a movement distance additionally movable according to the cooled coolant temperature, if the temperature of the coolant is cooled up to the second threshold temperature. However, it is not limited thereto.

As described above, the vehicle control device according to an embodiment may adjust the temperature of the coolant in advance before the vehicle travels, thus increasing a movement distance. The vehicle control device may adjust the temperature of the coolant in advance not to consume electrical energy for adjusting the temperature of the coolant while driving the vehicle, thus increasing the movable distance. The vehicle control method may be to cool the temperature of the coolant in advance not to use a refrigerant associated with an air conditioner cooling system to cool the coolant while the vehicle is traveling, thus improving the performance of the air conditioner cooling system.

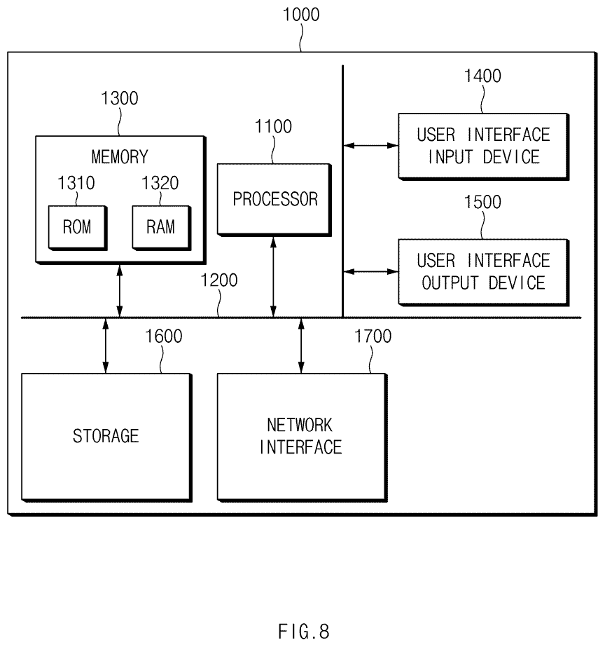

FIG. 8 illustrates a computing system associated with a vehicle control device or a vehicle control method according to an embodiment of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may adjust a temperature of the coolant before the vehicle travels.

The present technology may increase a drivable distance of the vehicle by adjusting the temperature of the coolant before the vehicle travels.

The present technology may determine at least one of a heat storage mode or a cool storage mode depending on an outside air temperature.

Furthermore, the present technology may identify a target temperature of the coolant depending on the outside air temperature and the target distance.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control device, comprising:
a processor;
a memory;
a battery;
a battery heater; and
a battery chiller,
wherein the processor is configured to:
determine a mode associated with a coolant for adjusting a temperature of the battery, using at least one of a target distance of a vehicle, a traveling start time, or an outside air temperature, or any combination thereof, before the vehicle travels;
identify a first threshold temperature using a designated first dataset, in response to determining the mode associated with the coolant is a heat storage mode, and heat a temperature of the coolant up to the first threshold temperature using the battery heater, while the coolant flows through a coolant flow line connected with the battery; and
identify a second threshold temperature using a designated second dataset, in response to determining the mode associated with the coolant is a cool storage mode, and cool the temperature of the coolant up to the second threshold temperature using the battery chiller, while the coolant flows through the coolant flow line.

2. The vehicle control device of claim 1, wherein the processor is configured to:
determine the mode associated with the coolant as the heat storage mode, if the outside air temperature is less than or equal to a first external temperature; and
identify the first threshold temperature, using the designated first dataset indicating temperature values of the coolant, the temperature values being set according to a temperature being less than or equal to the first external temperature and the target distance.

3. The vehicle control device of claim 1, wherein the processor is configured to:
determine the mode associated with the coolant as the cool storage mode, if the outside air temperature is greater than or equal to a second external temperature; and
identify the second threshold temperature, using the designated second dataset indicating temperature values of the coolant, the temperature values being set according to a temperature being greater than or equal to the second external temperature and the target distance.

4. The vehicle control device of claim 1, wherein the processor is configured to:
calculate a first spending time spent to heat the temperature of the coolant up to the first threshold temperature, using the outside air temperature and the first threshold temperature, in response to determining the mode associated with the coolant is the heat storage mode; and
initiate to drive the battery heater for heating the temperature of the coolant before the first spending time from the traveling start time.

5. The vehicle control device of claim 1, wherein the processor is configured to:
calculate a second spending time spent to cool the temperature of the coolant up to the second threshold temperature, using the outside air temperature and the second threshold temperature, in response to determining the mode associated with the coolant is the cool storage mode; and
initiate to drive the battery chiller for cooling the temperature of the coolant before the second spending time from the traveling start time.

6. The vehicle control device of claim 1, wherein the processor is configured to:
identify a first increase distance to increase by not heating the temperature of the coolant while the vehicle is traveling, based on the temperature of the coolant, the temperature being heated up to the first threshold temperature, if determining the mode associated with the coolant as the heat storage mode.

7. The vehicle control device of claim 1, wherein the processor is configured to:
identify a second increase distance to increase by not cooling the temperature of the coolant while the vehicle is traveling, based on the temperature of the coolant, the temperature being cooled up to the second threshold temperature, if determining the mode associated with the coolant as the cool storage mode.

8. The vehicle control device of claim 1, further comprising:
a water pump configured to cause flow of the coolant,
wherein the processor is configured to:
change the temperature of the coolant, using at least one of the battery heater or the battery chiller, while the coolant flows through the coolant flow line using the water pump, based on determining the mode associated with the coolant.

9. The vehicle control device of claim 1, wherein the processor is configured to:
additionally adjust the first threshold temperature or the second threshold temperature based on a weight.

10. The vehicle control device of claim 1, wherein the processor is configured to:
determine the mode associated with the coolant if a state of charge (SOC) of the battery is greater than or equal to a threshold charging capacity.

11. A vehicle control method, comprising:
determining a mode associated with a coolant for adjusting a temperature of the battery, using at least one of a target distance of a vehicle, a traveling start time, or an outside air temperature, before the vehicle travels;
in response to determining the mode associated with the coolant is a heat storage mode, identifying a first threshold temperature using a designated first dataset, and heating a temperature of the coolant up to the first threshold temperature using a battery heater, while the coolant flows through a coolant flow line connected with the battery; and
in response to determining the mode associated with the coolant is a cool storage mode, identifying a second threshold temperature using a designated second dataset, and cooling the temperature of the coolant up to the second threshold temperature using a battery chiller, while the coolant flows through the coolant flow line.

12. The vehicle control method of claim 11, wherein the determining of the mode associated with the coolant includes:
determining the mode associated with the coolant is the heat storage mode when the outside air temperature is less than or equal to a first external temperature; and
identifying the first threshold temperature, using the designated first dataset indicating temperature values of the coolant, the temperature values being set according to a temperature being less than or equal to the first external temperature and the target distance.

13. The vehicle control method of claim 11, wherein the determining of the mode associated with the coolant includes:
determining the mode associated with the coolant is the cool storage mode when the outside air temperature is greater than or equal to a second external temperature; and
identifying the second threshold temperature, using the designated second dataset indicating temperature values of the coolant, the temperature values being set according to a temperature being greater than or equal to the second external temperature and the target distance.

14. The vehicle control method of claim 11, wherein the identifying of the first threshold temperature includes:
calculating a first spending time spent to heat the temperature of the coolant up to the first threshold temperature using the outside air temperature and the first threshold temperature, if determining the mode associated with the coolant as the heat storage mode; and
initiating to drive the battery heater for heating the temperature of the coolant before the first spending time from the traveling start time.

15. The vehicle control method of claim 11, wherein the identifying of the second threshold temperature includes:
calculating a second spending time spent to cool the temperature of the coolant up to the second threshold temperature using the outside air temperature and the second threshold temperature, if determining the mode associated with the coolant as the cool storage mode; and
initiating to drive the battery chiller for cooling the temperature of the coolant before the second spending time from the traveling start time.

16. The vehicle control method of claim 11, wherein the heating of the temperature of the coolant up to the first threshold temperature includes:
identifying a first increase distance to increase by not heating the temperature of the coolant while the vehicle is traveling, based on the temperature of the coolant, the temperature being heated up to the first threshold temperature, in response to determining the mode associated with the coolant is the heat storage mode.

17. The vehicle control method of claim 11, wherein the cooling of the temperature of the coolant up to the second threshold temperature includes:
identifying a second increase distance to increase by not cooling the temperature of the coolant while the vehicle is traveling, based on the temperature of the coolant, the temperature being cooled up to the second threshold temperature, in response to determining the mode associated with the coolant is the cool storage mode.

18. The vehicle control method of claim 11, wherein the determining of the mode associated with the coolant includes:
changing the temperature of the coolant, using at least one of the battery heater or the battery chiller, while the coolant flows through the coolant flow line using a water pump, based on determining the mode associated with the coolant.

19. The vehicle control method of claim 11, further comprising:
additionally adjusting the first threshold temperature or the second threshold temperature based on a weight.

20. The vehicle control method of claim 11, wherein the determining of the mode associated with the coolant includes:
determining the mode associated with the coolant if a state of charge (SOC) of the battery is greater than or equal to a threshold charging capacity.
